(19) United States
(12) Patent Application Publication
(10) Pub. No.: US 2004/0073465 A1
(43) Pub. Date: Apr. 15, 2004

(54) Method for administering reimbursement account claims

(76) Inventor: David Wilson, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 10/271,144

(22) Filed: Oct. 14, 2002

(51) Int. Cl. G06F 17/60

(52) U.S. Cl. 705/4

(57) ABSTRACT

An improved health care plan is provided for use in the health care industry. The health care plan may include: a medical plan which provides coverage for medical expenses incurred by a health care recipient, where at least a portion of the medical expenses are not covered by the medical plan; an available flexible spending account which provides funds for medical expenses that are not covered by the medical plan; and an available health care reimbursement account which provides funds for medical expenses that are not covered by the medical plan, where an unused portion of the funds in the health care reimbursement account may be carried forward for use by the health care recipient in subsequent years and reimbursement for uncovered medical expenses is provided from the health care reimbursement account only when the funds in the flexible spending account have been expended.

### FIELD OF THE INVENTION

The present invention relates generally to a unique health care plan design and, more particularly, to a method for administering reimbursements claims submitted under this unique health care plan.

### BACKGROUND OF THE INVENTION

Flexible spending accounts (FSAs) have emerged as a common vehicle for reimbursing certain health care expenses. Flexible spending accounts generally allow employees the ability to establish reimbursement accounts which are funded by pre-tax payroll deductions as a means for paying for their uncovered health care expenses. Although contributions to such accounts may be made by either an employee or their employer, contributions are typically only made by the employee. A notable drawback of flexible spending accounts is that any unused portion of the funds in the account may not be rolled over to the next plan year for use by the employee. Flexible spending accounts are established as is well known in the art in accordance with §125 of the Internal Revenue Code. Such reimbursement accounts will be herein referred to as “flexible spending accounts”.

On Jun. 26, 2002, the U.S. Treasury and IRS released published guidance authorizing health reimbursement arrangements (HRAs), where unused dollars in such reimbursement accounts may be directly rollover from one plan year to succeeding plan years. Contributions for these types of reimbursement accounts are exclusively contributed by the employer for the benefit of the employee and may be used exclusively for the reimbursement of §213 health care expenses not otherwise reimbursed from any other source. Such reimbursement accounts will be herein referred to as “health care reimbursement accounts”. The guidance defined in Revenue Ruling (2002-41) and Notice (2002-45) provides substantial flexibility for an integrated health care plan design.

A standard health care plan design for integrating health care reimbursement accounts into traditional health plan coverage has emerged in the market place. The standard health care plan design is illustrated in FIG. 1. This standard plan design consists of a medical plan with a high deductible (e.g., $2,000 single/$4,000 family) complemented by an employer funded health care reimbursement account for reimbursement of incurred employee deductible and coinsurance obligations. If the employees' annual health care expenses under the plan are less than the dollars available under the health care reimbursement account, then the remaining account balance is rolled over to the next plan year for the employee's future benefit as defined by the plan.

This standard plan design has numerous disadvantages. First, the rapid movement to such a high deductible program creates a high psychological barrier to strong, appreciated, employee acceptance. Second, the plan design inherently limits the employee's experience as a financially engaged consumer in the plan. Since the first dollars of the deductible or coinsurance expenses incurred are reimbursable to the employee from the health care reimbursement account, there is no risk of contributions made by the employee until the balance of the account has been expended. Third, the plan design provides minimal motivation for employees to prepare and budget for expected medical expenses as compared to conventional flexible spending accounts.

Therefore, it is desirable to provide a unique health care plan design that addresses the aforementioned as well as other deficiencies with current health care plan designs.

### SUMMARY OF THE INVENTION

In accordance with the present invention, an improved health care plan is provided for use in the health care industry. The health care plan may include: a medical plan which provides coverage for medical expenses incurred by a health care recipient, where at least a portion of the medical expenses are not covered by the medical plan; an available flexible spending account which provides funds for medical expenses that are not covered by the medical plan; and an available health care reimbursement account which provides funds for medical expenses that are not covered by the medical plan, where an unused portion of the funds in the health care reimbursement account may be carried forward for use by the health care recipient in subsequent years and reimbursement for uncovered medical expenses is provided from the health care reimbursement account only when the funds in the flexible spending account have been expended.

In another aspect of the present invention, a method is provided for administering reimbursements claims submitted under the above-described health care plan. Initially, a flexible spending account and a health care reimbursement account are established for a health care recipient. Upon receipt of a reimbursement claim submitted on behalf of the health care recipient, a determination is made as to which account is to be used to reimburse the claim. When funds in the flexible spending account are available to the health care recipient, then an eligible claim is reimbursed using the funds from the flexible spending account. On the other hand, when the funds in the flexible spending account are not available to the health care recipient, then an eligible claim is reimbursed using the funds from the health care reimbursement account.

For a more complete understanding of the invention, its objects and advantages, reference may be had to the following specification and to the accompanying drawings.

### BRIEF DESCRIPTION OF THE DRAWINGS

FIG. 1 is a diagram of an exemplary health care plan design which has recently emerged in the market place;

FIG. 2 is a diagram of an improved health care plan design in accordance with the present invention;

FIG. 3 is a flowchart illustrating a method for administering reimbursements claims submitted under the health care plan of the present invention; and

FIGS. 4A-4C are diagram depicting exemplary health care scenarios in accordance with the present invention.

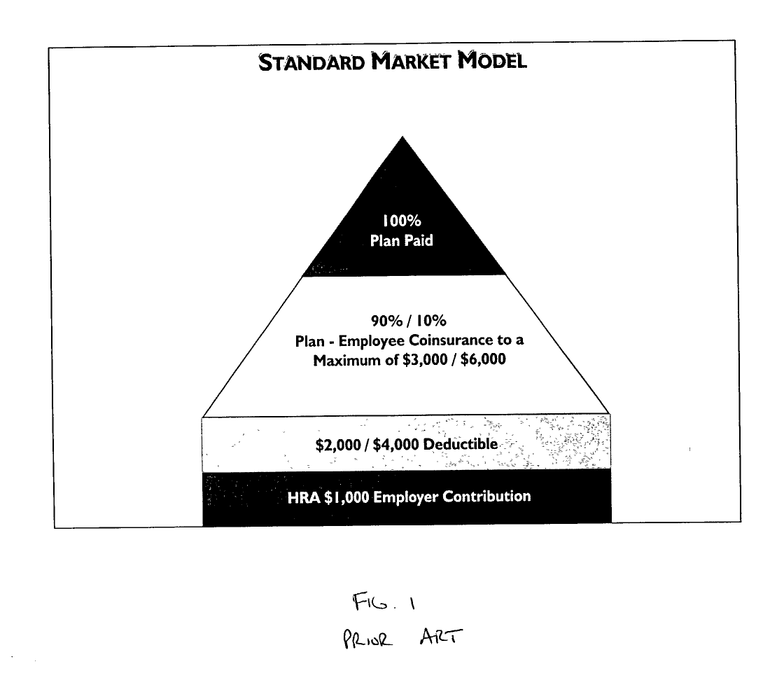

### DETAILED DESCRIPTION OF THE PREFERRED EMBODIMENTS

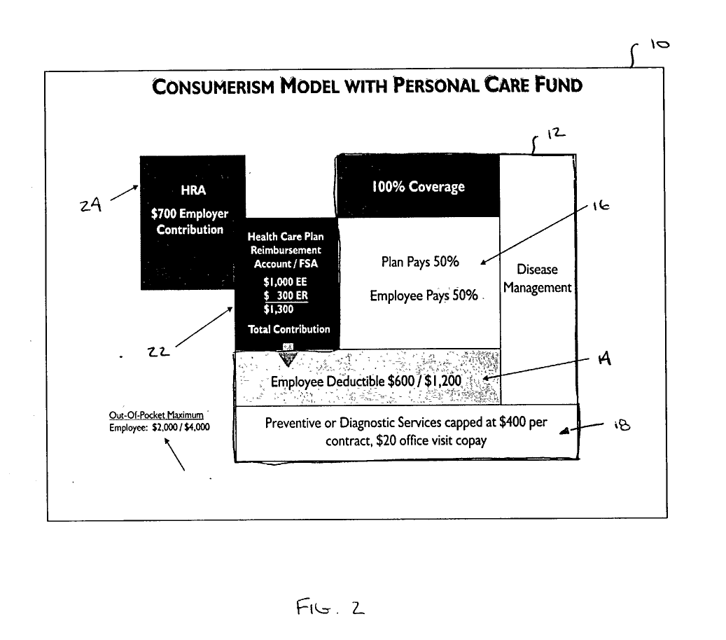

FIG. 2 illustrates an improved health care plan 10 in accordance with the present invention. The improved health care plan is comprised of three primary components: a medical plan 12, a flexible spending account 22, and a health care reimbursement account 24. While the following description is provided with reference to a particular health care plan design, it is readily understood that the broader aspects of the present invention are not limited to this particular plan design.

Medical plans 12 generally provide coverage for medical expenses incurred by a health care participant and its covered dependants as is well known in the art. However, at least a portion of incurred medical expenses may not be covered by the medical plan. Medical plans are typically made available to a health care participant by a health insurance entity as adopted by the employer of the health care participant. Thus, “health care recipient” is used herein to refer to the health care participant (i.e., the employee) and/or its covered dependants.

Medical plans 12 may have various requirements for health care recipients to pay for at least some of their incurred medical expenses. For instance, the medical plan 12 may include an employee deductible 14 as shown in FIG. 2. A deductible requires a health care recipient to pay for incurred medical expenses on an annual basis up to a predefined maximum amount before benefit payment begins under the medical plan. The deductible levels 14 of the present invention are preferably set at two to three times traditional deductible levels. For example, if a traditional deductible is on the order of $250 for individual coverage (or $500 for family coverage), then the deductible may be set on the order of $600 for individual coverage (or $1200 for family coverage). The more moderate deductible levels of the present invention are intended to provide an employee appreciated and highly accepted level of benefit value which may promote future employee acceptance of higher deductible obligations.

The medical plan 12 may further include a coinsurance obligation 16 as shown in FIG. 2. Once a health care recipient has satisfied their deductible obligation, the medical plan and the health care recipient are jointly responsible for incurred medical expenses up to some predefined maximum amount. Specifically, the health care recipient is responsible for paying a percentage of incurred medical expenses on an annual basis up to a predefined maximum out-of-pocket amount.

Traditionally, a health care recipient is responsible for approximately 20 percent of the medical expenses with an out-of-pocket maximum of $1,000 for individual coverage (or $2000 for family coverage) for health care provided by an “in-network” health care provider (i.e., a health care provider having a contractual relationship with the health insurance entity as is well known in the art). It is readily understood that the coinsurance obligations is typically higher for health care provided by an “out-of-network” provider. In accordance with the present invention, the coinsurance obligation is set greater than twenty five percent (preferably on the order of forty or forty percent) for health care provided by an “in-network” provider with a moderate coinsurance out-of-pocket limit on the order of $2,000 for individual coverage (or $4000 for family coverage).

In addition, the medical plan 12 may also include a preventive or diagnostic component 18 which requires a nominal copay (e.g., $10 per visit) by the health care recipient for these types of services. Beyond these obligations, the medical plan 12 typically provides complete coverage for any remaining incurred medical expenses. It is readily understood that only the primary aspects of the medical plan 12 have been discussed herein, but that other ancillary benefits may be incorporated into an exemplary medical plan.

The health care plan 10 further includes a flexible spending account 22 which provides funds for medical expenses that are not covered by the medical plan 12. In particular, the flexible spending account is established in accordance with §125 of the Internal Revenue Code. Although the flexible spending account may be funded by contributions from either the health care recipient or the employer of the health care recipient, the flexible spending account is preferably funded by contributions from both the health care recipient and the employer of the health care recipient, where the employer contributions are conditional upon contributions from the health care recipient. For instance, the employer may contribute 30 cents for every dollar contributed by the employee up to some predefined limit. Thus, the employer's matching contribution provides an incentive for the employee to establish a flexible spending account.

Similarly, the health care plan 10 includes a health care reimbursement account 24 which also provides funds for medical expenses that are not covered by the medical plan 12. In particular, the flexible spending account is established in accordance with §105 of the Internal Revenue Code. Unlike the flexible spending accounts, contributions to the health care reimbursement account 24 are only made by the employer. Of particular importance, reimbursement for uncovered medical expenses is provided from the health care reimbursement account 24 only when the funds in the flexible spending account 22 are not available to the health care recipient. For instance, reimbursement from the health care reimbursement account 24 preferably occurs only when the funds in the flexible spending account 22 have been expended; however, it is envisioned that the employer may establish other conditions when the funds in the flexible spending account are not available to the health care recipient. It is envisioned that the employer's contribution for the health care reimbursement account will be set at a moderate level (e.g., $700) in relation to levels emerging in the market place (i.e., on the order of $1,000), thereby reducing overall liability for the employer.

As further incentive for the health care recipient to establish a flexible spending account, the health care plan 10 may specify that the health care reimbursement account may not be used to reimburse any deductible paid by the health care recipient. In this way, the health care plan 10 of the present invention encourages the employee to establish a flexible spending account, and thus take an active role in planning and budgeting for expected medical expenses.

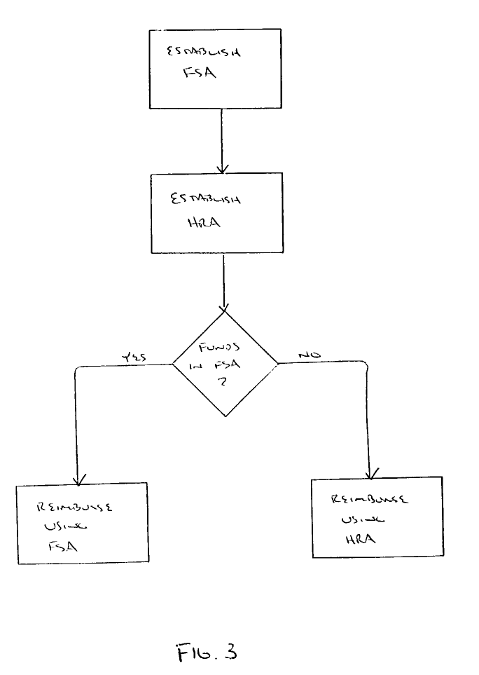

In another aspect of the present invention, a method 30 is provided for administering reimbursements claims submitted under the above-described health care plan. Referring to FIG. 3, a flexible spending account is established at step 32 and a health care reimbursement account is established at step 34 for the health care recipient as described above.

Upon receipt of a reimbursement claim submitted on behalf of the health care recipient, a determination is made at step 36 as to which account is to be used to reimburse the claim. When funds in the flexible spending account are available to the health care recipient, then an eligible claim is reimbursed using the funds from the flexible spending account as shown at step 38. On the other hand, when funds in the flexible spending account are not available to the health care recipient, then an eligible claim is reimbursed using available funds from the health care reimbursement account as shown at step 39.

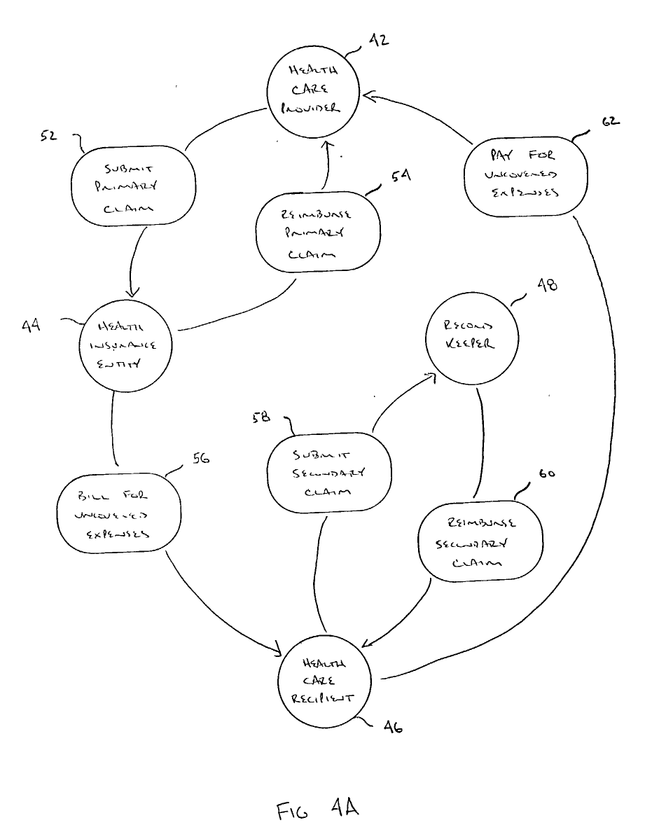

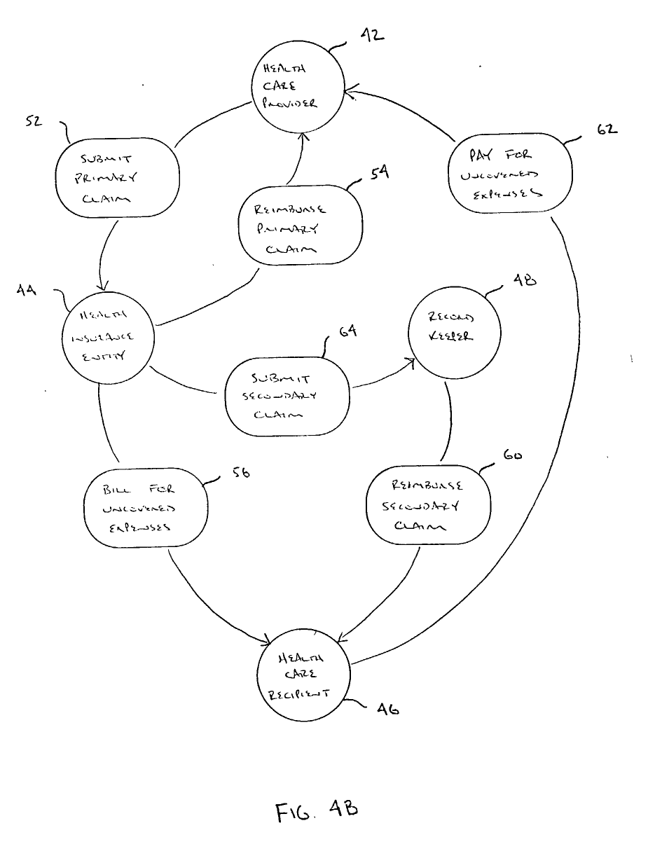

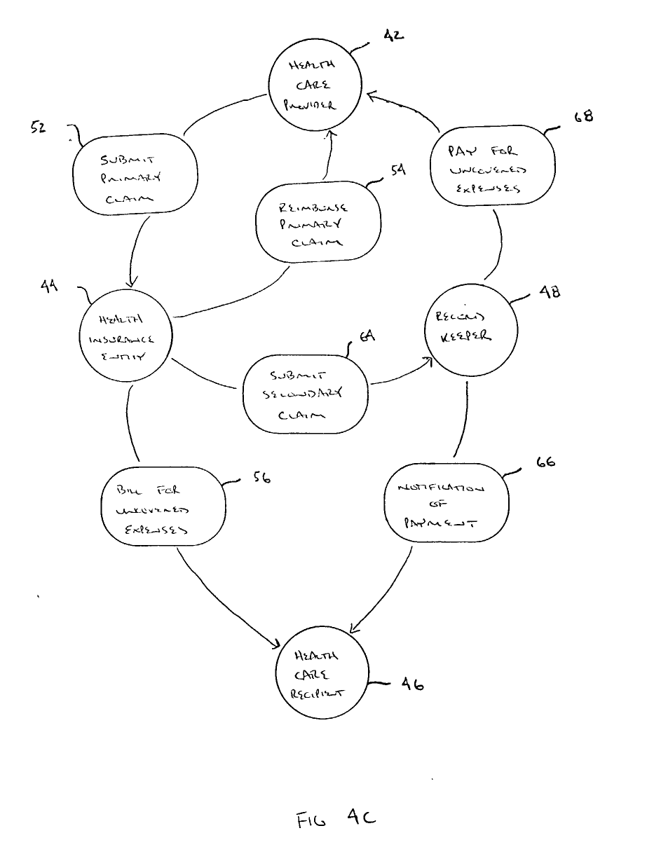

This method for administering reimbursement claims is further described in the context of three exemplary health care scenarios as shown in FIGS. 4A-4C. In each case, the process begins when a health care provider administers health care to a health care recipient, thereby incurring medical expenses which may be covered under the recipient's health care plan.

Referring to FIG. 4A, the health care provider 42 submits a claim for the incurred medical expenses on behalf of the health care recipient 46 to the health insurance entity 44 as shown at 52. The health insurance entity 44 in turn pays the health care provider 42 for the incurred medical expenses that are covered under the recipient's medical plan as shown at 54. This type of claim will be herein referred to as “the primary medical claim”. However, as discussed above, at least a portion of the medical expenses may not be covered under the medical plan. Therefore, the health insurance entity 44 also sends a invoice for the uncovered medical expenses to the health care recipient 46 as shown at 56.

In each of these scenarios, it is assumed that the health care recipient 46 has established at least one of a flexible spending account or a health care reimbursement account as described above. For simplicity, the entity responsible for administering these types of accounts is designated the record keeper 48. The record keeper 48 is preferably a third party that administers an employee benefit program on behalf of the health care recipient's employer as is well known in the art. However, it is readily understood that this function may be performed by either the employer or the health insurance entity, such that either of these two parties also falls within the scope of the term record keeper.

Upon receipt of an invoice from the health insurance entity 44, the health care recipient 46 may submit a reimbursement claim to the record keeper 48 as shown at 58. The record keeper 48 will process the reimbursement claim in accordance with the methodology set forth above. In other words, the record keeper 48 determines which, if any, available accounts may be used to reimburse the claim, and then processes the claim accordingly. If approved, the record keeper 48 provides reimbursement for the uncovered medical expenses to the health care recipient 46 as shown at 60. Contemporaneously with submitting the reimbursement claim, the health care recipient 46 also submits payment for the uncovered medical expenses to the health care provider 42 as shown at 62. It is readily understood that payment to the health care provider may occur before or after the health care recipient 46 receives reimbursement from the record keeper 48.

FIG. 4B illustrates an exemplary health care scenario similar to the scenario described above. However, in this scenario, the secondary reimbursement claim is submitted directly from the health insurance entity 44 to the record keeper 48. Upon receipt of the primary claim from the health care provider, the health insurance entity 44 sends a invoice for the uncovered medical expenses to the health care recipient 46 as shown at 56, as well as submits a claim for the uncovered medical expenses to the record keeper 48 as shown at 64. This secondary reimbursement claim is preferably submitted in electronic form to the record keeper 48. The record keeper 48 in turn processes the reimbursement claim as described above. The remainder of the process is the same as set forth in relation to FIG. 4A.

Likewise, FIG. 4C illustrates an exemplary health care scenario similar to the scenario illustrated in FIG. 4A. In this scenario, payment for uncovered medical expenses is made directly from the record keeper 48 to the health care provider 42. Upon receipt of the secondary reimbursement claim, the record keeper 48 submits payment to the health care provider 42 as shown at 66, as well as provides notification of the payment to the health care recipient as shown at 68. In this way, the health care recipient 46 receives an invoice for the uncovered medical expenses and notification of payment which may be retained for recording purposes. In an alternative scenario, the secondary reimbursement claim may have been submitted by the health care recipient (as shown in FIG. 4A); otherwise, the remainder of the process is the same as set forth in relation to FIG. 4C.

Reimbursement claims may be processed in part or in entirety by a computer-implemented system as is known in the art. Likewise, it is envisioned that reimbursement of primary and/or secondary reimbursement claims in accordance with the present invention may be processed in part or in entirety by a computer-implemented system. It is readily understood that only the relevant steps of the methodology are discussed above, but that other software-implemented instructions may be needed to control the overall operation of the computer-implemented system.

While the above description has been provided with reference to reimbursing medical expenses that are incurred under a medical plan, it is envisioned that such reimbursement accounts may be used to reimburse other types of health care expenses. For instance, eligible health care expenses incurred under a drug benefit plan and/or an employee assist plan may also be reimbursed using funds from either a flexible spending account or a health care reimbursement account in accordance with the methodology of the present invention. It is readily understood that the drug benefit plan and/or employee assist plan may be provided by an employer as part of a medical plan 12 or on a stand-alone basis within the scope of the overall health care plan 10.

While the invention has been described in its presently preferred form, it will be understood that the invention is capable of modification without departing from the spirit of the invention as set forth in the appended claims.

What is claimed is:

1. An improved health care plan, comprising:
a medical plan which provides coverage for medical expenses incurred by a health care recipient, where at least a portion of the medical expenses are not covered by the medical plan;
an available flexible spending account which provides funds for medical expenses that are not covered by the medical plan; and
an available health care reimbursement account which provides funds for medical expenses that are not covered by the medical plan, where an unused portion of the funds in the health care reimbursement account may be carried forward for use by the health care recipient in subsequent years and reimbursement for uncovered medical expenses is provided from the health care reimbursement account only when the funds in the flexible spending account have been expended.

2. The improved health care plan of claim 1 wherein the medical plan requires the health care recipient to pay a percentage of incurred medical expenses up to a predefined maximum amount, where the percentage is greater than twenty five percent.

3. The improved health care plan of claim 2 wherein the percentage is on the order of forty five percent.

4. The improved health care plan of claim 1 wherein an unused portion of the funds in the flexible spending account are unavailable to the health care recipient in subsequent years.

5. The improved health care plan of claim 1 wherein the flexible spending account is funded by contributions from at least one of the health care recipient and an employer of the health care recipient.

6. The improved health care plan of claim 1 wherein the health care reimbursement account is funded by contributions from an employer of the health care recipient.

7. The improved health care plan of claim 1 wherein the flexible spending account is established in accordance with §125 of the Internal Revenue Code.

8. The improved health care plan of claim 1 wherein the health care reimbursement account is established in accordance with §105 of the Internal Revenue Code.

9. The improved health care plan of claim 1 further includes an incentive for the health care recipient to establish a flexible spending account.

10. The improved health care plan of claim 1 wherein the flexible spending account is funded by contributions from the health care recipient and matching contributions from an employer of the health care recipient, where the matching contributions are conditional upon contributions from the health care recipient, thereby providing an incentive for the health care recipient to establish a flexible spending account.

11. The improved health care plan of claim 1 wherein the medical plan requires the health care recipient to pay a deductible for incurred medical expenses up to a predefined maximum amount and the health care reimbursement account may not be used to reimburse any deductible paid by the health care recipient, thereby providing an incentive for the health care recipient to establish a flexible spending account.

12. A method for administering a reimbursement claim submitted on behalf of a health care recipient under a medical plan; comprising:
providing a health care flexible spending account for the health care recipient, the flexible spending account providing funds for medical expenses that are not covered by the recipient's medical plan;
providing a health care reimbursement account for the health care recipient, the health care reimbursement account providing funds for medical expenses that are not covered by the recipient's medical plan, where an unused portion of the funds may be carried forward for use by the health care recipient in subsequent years;
reimbursing the recipient for medical expenses that were not covered by the recipient's medical plan using the funds from the flexible spending account; and
reimbursing the recipient for medical expenses that were not covered by the recipient's medical plan using the funds from the health care reimbursement account when the funds in the flexible spending account are not available to the health care recipient.

13. The method of claim 12 wherein an unused portion of the funds in the flexible spending account are unavailable to the health care recipient in subsequent years.

14. The method of claim 12 further comprises funding the flexible spending account by contributions from at least one of the health care recipient and an employer of the health care recipient.

15. The method of claim 12 further comprises funding the flexible spending account by contributions from the health care recipient and matching contributions from an employer of the health care recipient, where the matching contributions are conditional upon contributions from the health care recipient.

16. The method of claim 12 further comprises funding the health care reimbursement account by contributions from an employer of the health care recipient.

17. The method of claim 12 further comprises reimbursing the recipient using the funds from the health care reimbursement account only when the available funds in the flexible spending account have been expended.

18. The method of claim 12 wherein the flexible spending account is established in accordance with §125 of the Internal Revenue Code.

19. The method of claim 12 wherein the health care reimbursement account is established in accordance with §105 of the Internal Revenue Code.

20. The method of claim 12 further comprises receiving a reimbursement claim for the uncovered medical expenses from a health care recipient; and, upon receipt of the reimbursement claim, providing reimbursement to the health care recipient from at least one of the flexible spending account and the health care reimbursement account.

21. The method of claim 12 further comprises receiving a reimbursement claim for the uncovered medical expenses from a health insurance entity; and, upon receipt of the reimbursement claim, providing reimbursement to the health care recipient from at least one of the flexible spending account and the health care reimbursement account.

22. The method of claim 20 further comprises submitting payment by the health care recipient for medical expenses that are not covered by the recipient's medical plan to a health care provider.

23. A method for administering reimbursement of medical expenses incurred under a medical plan adopted by an employer and provided by a health insurance entity; comprising:
providing a flexible spending account for a health care recipient, the flexible spending account providing funds for medical expenses that are not covered by the recipient's medical plan;
providing a health care reimbursement account for the health care recipient, the health care reimbursement account providing funds for medical expenses that are not covered by the recipient's medical plan, such that an unused portion of the funds may be carried forward for use by the health care recipient in subsequent years;
receiving a reimbursement claim for medical expenses that are not covered under the medical plan; and
reimbursing the reimbursement claim from at least one of the flexible spending account and the health care reimbursement account.

24. The method of claim 23 wherein the step of reimbursing the reimbursement claim further comprises using the funds from the flexible spending account to reimburse the claim; and, when the funds in the flexible spending account are not available to the recipient, using the funds from the health care reimbursement account to reimburse the claim.

25. The method of claim 23 wherein the flexible spending account and the health care reimbursement account are administered by health care plan record keeper, such that the reimbursement claim for uncovered medical expenses is submitted to the health care plan record keeper.

26. The method of claim 25 wherein the health care plan record keeper is a third party entity independent from the employer of the health care recipient and the health insurance entity.

27. The method of claim 25 further comprises submitting the reimbursement claim for the uncovered medical expenses by the health care recipient to the health care plan record keeper.

28. The method of claim 25 further comprises submitting the reimbursement claim for the uncovered medical expenses by the health insurance entity to the health care plan record keeper.

29. The method of claim 23 wherein the step of reimbursing the reimbursement claim further comprises providing reimbursement to the health care recipient.

30. The method of claim 23 wherein the step of reimbursing the reimbursement claim further comprises providing reimbursement to the health care provider.
